(19) United States
(12) Patent Application Publication
(10) Pub. No.: US 2026/0357829 A1
(43) Pub. Date: Nov. 12, 2026

(54) HYDRAULIC SYSTEM

(71) Applicant: KAWASAKI JUKOGYO KABUSHIKI KAISHA, Kobe-shi, Hyogo (JP)

(72) Inventors: Ryo YAMAMOTO, Kobe-shi (JP); Hideki TANAKA, Kobe-shi (JP); Hiroaki MITSUI, Kobe-shi (JP)

(73) Assignee: KAWASAKI JUKOGYO KABUSHIKI KAISHA, Kobe-shi, Hyogo (JP)

(21) Appl. No.: 19/134,902

(22) PCT Filed: Sep. 5, 2023
(86) PCT No.: PCT/JP2023/032408

§ 371 Date: Jun. 2, 2025

(30) Foreign Application Priority Data
Dec. 21, 2022 (JP) 2022-204318

(51) Int. Cl. F15B 21/0423

(52) U.S. Cl. CPC F15B 21/0423; F15B 2211/20515; F15B 2211/20561; F15B 2211/20576; F15B 2211/62; F15B 2211/625

(57) ABSTRACT

A hydraulic system includes: a first bi-directional pump connected to a head-side chamber of a single-rod cylinder by a head-side line and connected to a rod-side chamber of the single-rod cylinder by a rod-side line; and a second bi-directional pump connected to the head-side line by a first supply/discharge line and connected to storage equipment by a second supply/discharge line. The hydraulic system further includes: an electric motor that drives the first bi-directional pump and the second bi-directional pump in a same direction; and a cooler located on the second supply/discharge line.

### TECHNICAL FIELD

The present disclosure relates to a hydraulic system for a single-rod cylinder.

### BACKGROUND ART

Conventionally, there is a known hydraulic system for a single-rod cylinder, the hydraulic system including a bi-directional pump that is connected to the single-rod cylinder in a manner to form a closed loop. For example, Patent Literature 1 discloses a hydraulic system 100 as shown in FIG. 7.

The hydraulic system 100 includes a first bi-directional pump 110 and a second bi-directional pump 120. The first bi-directional pump 110 is connected to a head-side chamber 210 of a single-rod cylinder 200 by a head-side line 111, and connected to a rod-side chamber 220 of the single-rod cylinder 200 by a rod-side line 112. The second bi-directional pump 120 is a pump with which to eliminate a flow rate difference between the head-side chamber 210 and the rod-side chamber 220 of the single-rod cylinder 200, i.e., a difference between an inflow flow rate and an outflow flow rate. The second bi-directional pump 120 is connected to the head-side line 111 by a first supply/discharge line 121, and connected to a tank by a second supply/discharge line 122.

The first bi-directional pump 110 and the second bi-directional pump 120 are driven in the same direction by an electric motor 130. To be more specific, at the time of extending the single-rod cylinder 200, i.e., at the time of moving the rod forward, the electric motor 130 drives the first bi-directional pump 110 and the second bi-directional pump 120 in a first direction, and at the time of retracting the single-rod cylinder 200, i.e., at the time of moving the rod backward, the electric motor 130 drives the first bi-directional pump 110 and the second bi-directional pump 120 in a second direction opposite to the first direction. When the first bi-directional pump 110 and the second bi-directional pump 120 are driven in the first direction, these pumps deliver a hydraulic liquid to the head-side chamber 210, and when the first bi-directional pump 110 and the second bi-directional pump 120 are driven in the second direction, these pumps suck the hydraulic liquid from the head-side chamber 210.

### CITATION LIST

### Patent Literature

PTL 1: Japanese Laid-Open Patent Application Publication No. 2013-245740

### SUMMARY OF INVENTION

### Technical Problem

In the hydraulic system 100 as shown in FIG. 7, there is a desire to cool the hydraulic liquid therein.

In view of the above, an object of the present disclosure is to provide a hydraulic system that makes it possible to cool a hydraulic liquid in a configuration in which a first bi-directional pump and a second bi-directional pump are used for a single-rod cylinder.

### Solution to Problem

One aspect of the present disclosure provides a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line and connected to storage equipment by a second supply/discharge line; an electric motor that drives the first bi-directional pump and the second bi-directional pump in a same direction; and a cooler located on the second supply/discharge line.

Another aspect of the present disclosure provides a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line and connected to storage equipment by a second supply/discharge line; an electric motor that drives the first bi-directional pump and the second bi-directional pump in a same direction; a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and a cooler located on the third discharge line.

### Advantageous Effects of Invention

The present disclosure provides a hydraulic system that makes it possible to cool a hydraulic liquid in a configuration in which a first bi-directional pump and a second bi-directional pump are used for a single-rod cylinder.

### BRIEF DESCRIPTION OF DRAWINGS

FIG. 1 shows a schematic configuration of a hydraulic system according to Embodiment 1.

FIG. 2 shows a schematic configuration of a variation of the hydraulic system.

FIG. 3 shows a schematic configuration of a hydraulic system according to Embodiment 2.

FIG. 4 shows a schematic configuration of a hydraulic system according to Embodiment 3.

FIG. 5 shows a variation of a low-pressure selection valve.

FIG. 6 shows another variation of the low-pressure selection valve.

FIG. 7 shows a schematic configuration of a conventional hydraulic system.

### DESCRIPTION OF EMBODIMENTS

### Embodiment 1

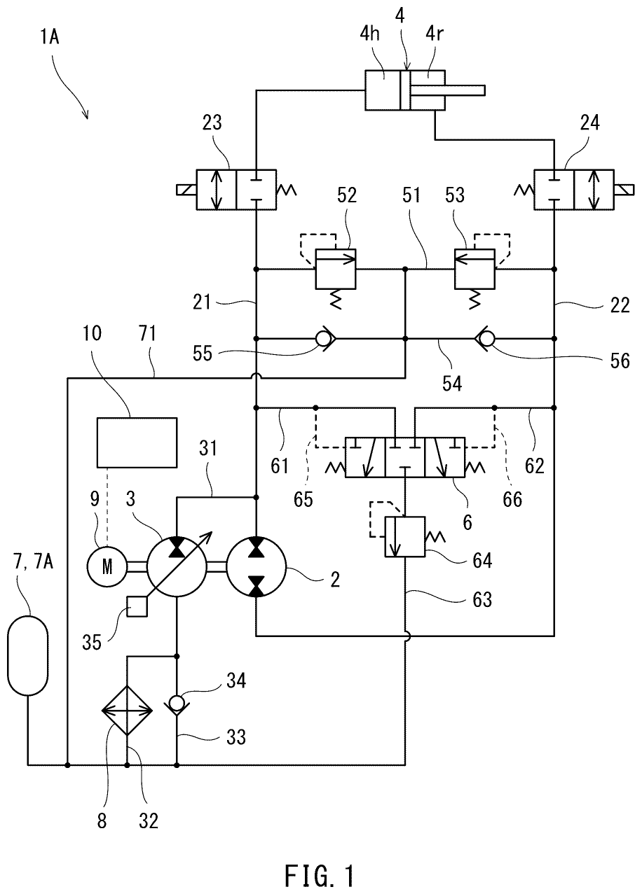

FIG. 1 shows a hydraulic system 1A according to Embodiment 1. The hydraulic system 1A is a hydraulic system for a single-rod cylinder 4 including a head-side chamber 4h and a rod-side chamber 4r. Typically, a hydraulic liquid used in the hydraulic system 1A is oil.

Specifically, the hydraulic system 1A includes: a first bi-directional pump 2, which is connected to the single-rod cylinder 4 in a manner to form a closed loop; and a second bi-directional pump 3, with which to eliminate a flow rate difference between the head-side chamber 4h and the rod-side chamber 4r of the single-rod cylinder 4, i.e., a difference between an inflow flow rate and an outflow flow rate. The hydraulic system 1A further includes storage equipment 7, which stores the hydraulic liquid therein.

In the present embodiment, the storage equipment 7 is an accumulator 7A, which stores the hydraulic liquid in a pressurized state. The single-rod cylinder 4, the first bi-directional pump 2, the second bi-directional pump 3, and the accumulator 7A, together with below-described lines, form a closed circuit.

To be more specific, the first bi-directional pump 2 is connected to the head-side chamber 4h of the single-rod cylinder 4 by a head-side line 21, and connected to the rod-side chamber 4r of the single-rod cylinder 4 by a rod-side line 22. The second bi-directional pump 3 is connected to the head-side line 21 by a first supply/discharge line 31, and connected to the accumulator 7A by a second supply/discharge line 32.

The setting pressure of the accumulator 7A is, for example, within a range from 0.1 to 2 MPa. The “setting pressure of the accumulator 7A” herein means a pressure at which an inflow of the hydraulic liquid into the accumulator 7A is enabled.

In the present embodiment, a cooler 8 is located on the second supply/discharge line 32. A parallel line 33 is connected to the second supply/discharge line 32, such that the parallel line 33 bypasses the cooler 8. A check valve 34 is located on the parallel line 33. The check valve 34 allows a flow from the accumulator 7A toward the second bi-directional pump 3, but prevents the reverse flow. The cracking pressure of the check valve 34 is set lower than a pressure loss in the cooler 8.

A first lock valve 23, which is an on-off valve, is located on the head-side line 21. A second lock valve 24, which is an on-off valve, is located on the rod-side line 22. The first lock valve 23 and the second lock valve 24 are controlled by control circuitry 10. In FIG. 1, the illustration of part of signal lines is omitted for the purpose of simplifying the drawing. The control circuitry 10 opens the first lock valve 23 and the second lock valve 24 when moving, i.e., extending or retracting, the single-rod cylinder 4. Except when moving (extending or retracting) the single-rod cylinder 4, the control circuitry 10 closes the first lock valve 23 and the second lock valve 24.

The head-side line 21 and the rod-side line 22 are connected to each other by a first bridge line 51 and a second bridge line 54. A pair of relief valves 52 and 53 are located on the first bridge line 51 such that the relief valves 52 and 53 are oriented in opposite directions to each other, and a pair of check valves 55 and 56 are located on the second bridge line 54 such that the check valves 55 and 56 are oriented in opposite directions to each other.

In the illustrated example, the first bridge line 51 and the second bridge line 54 are connected to the head-side line 21 and the rod-side line 22 at positions between the first bi-directional pump 2 and the first and second lock valves 23 and 24. Alternatively, the first bridge line 51 and the second bridge line 54 may be connected to the head-side line 21 and the rod-side line 22 at positions between the single-rod cylinder 4 and the first and second lock valves 23 and 24. Portions of the first bridge line 51 and the second bridge line 54, for example, both end portions thereof and central portions thereof, may merge together to serve as shared passages.

The relief valve 52 opens when the pressure of the head-side line 21 has become excessively high, and the relief valve 53 opens when the pressure of the rod-side line 22 has become excessively high. The relief pressure of each of the relief valves 52 and 53 is set to a relatively high pressure that is, for example, within a range from 25 to 35 MPa.

The check valve 55 allows a flow from the middle of the second bridge line 54 toward the head-side line 21, but prevents the reverse flow. The check valve 56 allows a flow from the middle of the second bridge line 54 toward the rod-side line 22, but presents the reverse flow.

A portion of the first bridge line 51 between the relief valves 52 and 53 and a portion of the second bridge line 54 between the check valves 55 and 56 are connected to a portion of the second supply/discharge line 32 between the cooler 8 and the accumulator 7A by a relay line 71.

Each of the first bi-directional pump 2 and the second bi-directional pump 3 is, for example, an axial piston pump. The axial piston pump is, for example, a swash plate pump or a bent axis pump. In the present embodiment, the first bi-directional pump 2 is a fixed displacement pump, and the second bi-directional pump 3 is a variable displacement pump. Alternatively, the first bi-directional pump 2 may be a variable displacement pump. Further alternatively, both the first bi-directional pump 2 and the second bi-directional pump 3 may be fixed displacement pumps.

The displacement of the second bi-directional pump 3 is changed by a regulator 35. The regulator 35 is controlled by the control circuitry 10. For example, in a case where the second bi-directional pump 3 is a swash plate pump, the regulator 35 may electrically change a hydraulic pressure applied to a servo piston coupled to the swash plate of the second bi-directional pump 3, or may be an electric actuator coupled to the swash plate of the second bi-directional pump 3.

The first bi-directional pump 2 and the second bi-directional pump 3 are driven in the same direction by an electric motor 9. The first bi-directional pump 2 and the second bi-directional pump 3 may be located such that their center axes are coaxial with each other, or such that their center axes are parallel to each other. The former is called a tandem type, and the latter is called a parallel type.

The electric motor 9 is controlled by the control circuitry 10. At the time of extending the single-rod cylinder 4, the electric motor 9 drives the first bi-directional pump 2 and the second bi-directional pump 3 in a first direction, and at the time of retracting the single-rod cylinder 4, the electric motor 9 drives the first bi-directional pump 2 and the second bi-directional pump 3 in a second direction opposite to the first direction. When the first bi-directional pump 2 and the second bi-directional pump 3 are driven in the first direction, these pumps deliver the hydraulic liquid to the head-side chamber 4h, and when the first bi-directional pump 2 and the second bi-directional pump 3 are driven in the second direction, these pumps suck the hydraulic liquid from the head-side chamber 4h.

Further, the present embodiment adopts a low-pressure selection valve 6, which is connected to the head-side line 21 by a first discharge line 61 and connected to the rod-side line 22 by a second discharge line 62. The low-pressure selection valve 6 is connected to a portion of the second supply/discharge line 32 between the cooler 8 and the accumulator 7A by a third discharge line 63.

In the present embodiment, a relief valve 64 is located on the third discharge line 63. The relief valve 64 serves to keep a low pressure in the closed loop, which is formed by the single-rod cylinder 4, the head-side line 21, the rod-side line 22, and the first bi-directional pump 2, high to some extent. The relief pressure of the relief valve 64 is set to a relatively low pressure that is, for example, within a range from 0.1 to 2 MPa. The low pressure in the closed loop is the sum of the setting pressure of the accumulator 7A and the setting pressure of the relief valve 64, and is, for example, 1 to 2 MPa. In a case where the setting pressure of the accumulator 7A is relatively high, the relief valve 64 can be eliminated.

The low-pressure selection valve 6 is switched between a neutral position, a head-side discharge position, and a rod-side discharge position. In FIG. 1, the middle position is the neutral position; the right-side position is the head-side discharge position; and the left-side position is the rod-side discharge position. When the low-pressure selection valve 6 is in the neutral position, the low-pressure selection valve 6 blocks the first discharge line 61 and the second discharge line 62. When the low-pressure selection valve 6 is in the head-side discharge position, the low-pressure selection valve 6 allows the first discharge line 61 to communicate with the third discharge line 63 while blocking the second discharge line 62. When the low-pressure selection valve 6 is in the rod-side discharge position, the low-pressure selection valve 6 allows the second discharge line 62 to communicate with the third discharge line 63 while blocking the first discharge line 61.

In the present embodiment, the low-pressure selection valve 6 is a pilot-type three-position valve. Accordingly, a pressure Ph of the head-side chamber 4h is led to the low-pressure selection valve 6 through a first pilot line 65, and a pressure Pr of the rod-side chamber 4r is led to the low-pressure selection valve 6 through a second pilot line 66. The first pilot line 65 is a pilot line with which to switch the low-pressure selection valve 6 from the neutral position to the rod-side discharge position, and the second pilot line 66 is a pilot line with which to switch the low-pressure selection valve 6 from the neutral position to the head-side discharge position. In the illustrated example, the first pilot line 65 and the second pilot line 66 are branched off from the first discharge line 61 and the second discharge line 62, respectively. Alternatively, the first pilot line 65 may be branched off from the head-side line 21, and the second pilot line 66 may be branched off from the rod-side line 22.

The low-pressure selection valve 6 is switched to the rod-side discharge position when the pressure Pr of the rod-side chamber 4r is lower than the pressure Ph of the head-side chamber 4h, and switched to the head-side discharge position when the pressure Ph of the head-side chamber 4h is lower than the pressure Pr of the rod-side chamber 4r. In the present embodiment, when a pressure difference ΔP between the pressure Ph of the head-side chamber 4h and the pressure Pr of the rod-side chamber 4r, i.e., the absolute value of a difference between the pressure Ph and the pressure Pr, has become greater than or equal to a threshold Pt, the low-pressure selection valve 6 is switched from the neutral position to the rod-side discharge position or to the head-side discharge position. For example, the threshold Pt is within a range from 0.5 to 3 MPa. The threshold Pt at the time of extending the cylinder and the threshold Pt at the time of retracting the cylinder may be different from each other.

Next, one example of control performed by the control circuitry 10 is described. The control performed by the control circuitry 10 is not limited to that described below, but is modifiable as necessary.

Regarding the control circuitry 10, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the present disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The control circuitry 10 receives inputs of a first operation signal and a second operation signal. The first operation signal is an extension command to the single-rod cylinder 4, and the second operation signal is a retraction command to the single-rod cylinder 4. The control circuitry 10 further receives inputs of the pressure Ph of the head-side chamber 4h and the pressure Pr of the rod-side chamber 4r, each of which is measured by a pressure sensor, or receives an input of the pressure difference ΔP between the pressure Ph of the head-side chamber 4h and the pressure Pr of the rod-side chamber 4r, the pressure difference ΔP being measured by a pressure difference meter.

### 1. Cylinder Extension

When the first operation signal is inputted to the control circuitry 10, the control circuitry 10 rotates the electric motor 9 in the first direction. As a result, the first bi-directional pump 2 and the second bi-directional pump 3 are driven in the first direction; the first bi-directional pump 2 sucks the hydraulic liquid through the rod-side line 22; and the second bi-directional pump 3 sucks the hydraulic liquid through the second supply/discharge line 32 and the parallel line 33. Also, the first bi-directional pump 2 delivers the hydraulic liquid though the head-side line 21, and the second bi-directional pump 3 delivers the hydraulic liquid through the first supply/discharge line 31.

Regarding the suction of the hydraulic liquid by the second bi-directional pump 3, more specifically, the second bi-directional pump 3 sucks the hydraulic liquid from the accumulator 7A through part of the second supply/discharge line 32 on the accumulator 7A side, the parallel line 33, and part of the second supply/discharge line 32 on the second bi-directional pump 3 side, because, as mentioned above, the cracking pressure of the check valve 34 is set lower than a pressure loss in the cooler 8. That is, when the second bi-directional pump 3 is driven in the first direction, almost none of the hydraulic liquid passes through the cooler 8.

In a case where the pressure difference ΔP between the pressure Ph of the head-side chamber 4h and the pressure Pr of the rod-side chamber 4r is less than the threshold Pt, the control circuitry 10 controls the regulator 35 such that a displacement q2 of the second bi-directional pump 3 is a reference displacement qr. The reference displacement qr is a result of multiplying a displacement q1 of the first bi-directional pump 2 by the ratio of a cross-sectional area Ac of the rod of the single-rod cylinder 4 to a pressure receiving area Ar of the rod-side chamber 4r, i.e., qr=Ac/Ar×q1. That is, in the case of q2=qr, theoretically, there is neither excess nor deficiency in the inflow flow rate to the single-rod cylinder 4 or in the outflow flow rate from the single-rod cylinder 4. Accordingly, the supply of the hydraulic liquid to the head-side line 21 or the rod-side line 22 from the accumulator 7A through part of the second bridge line 54, the relay line 71, and part of the second supply/discharge line 32 is not performed, and the discharge of the hydraulic liquid from the head-side line 21 or the rod-side line 22 through the first discharge line 61 or the second discharge line 62 is not performed.

On the other hand, in a case where the pressure difference ΔP is greater than or equal to the threshold Pt, the control circuitry 10 controls the regulator 35 such that the displacement q2 of the second bi-directional pump 3 is greater than the reference displacement qr by a first predetermined amount Δq1, i.e., q2=qr+Δq1. For example, Δq1 is within a range from 1 to 10% of qr.

For example, in a case where a load in the retracting direction is applied to the single-rod cylinder 4, the pressure Ph of the head-side chamber 4h becomes higher than the pressure Pr of the rod-side chamber 4r by the threshold Pt or greater, and in a case where a load in the extending direction is applied to the single-rod cylinder 4, the pressure Pr of the rod-side chamber 4r becomes higher than the pressure Pr of the head-side chamber 4h by the threshold Pt or greater.

In a case where the pressure Ph of the head-side chamber 4h has become higher than the pressure Pr of the rod-side chamber 4r by the threshold Pt or greater, the low-pressure selection valve 6 is switched to the rod-side discharge position. As a result, an excess amount corresponding to the first predetermined amount Δq1 is discharged from the rod-side line 22 to the accumulator 7A through the second discharge line 62, the low-pressure selection valve 6, the third discharge line 63, and part of the second supply/discharge line 32.

On the other hand, in a case where the pressure Pr of the rod-side chamber 4r has become higher than the pressure Pr of the head-side chamber 4h by the threshold Pt or greater, the low-pressure selection valve 6 is switched to the head-side discharge position. As a result, an excess amount corresponding to the first predetermined amount Δq1 is discharged from the head-side line 21 to the accumulator 7A through the first discharge line 61, the low-pressure selection valve 6, the third discharge line 63, and part of the second supply/discharge line 32.

### 2. Cylinder Retraction

When the second operation signal is inputted to the control circuitry 10, the control circuitry 10 rotates the electric motor 9 in the second direction. As a result, the first bi-directional pump 2 and the second bi-directional pump 3 are driven in the second direction; the first bi-directional pump 2 sucks the hydraulic liquid through the head-side line 21; and the second bi-directional pump 3 sucks the hydraulic liquid through the first supply/discharge line 31. Also, the first bi-directional pump 2 delivers the hydraulic liquid through the rod-side line 22, and the second bi-directional pump 3 delivers the hydraulic liquid through the second supply/discharge line 32.

Regarding the delivery of the hydraulic liquid by the second bi-directional pump 3, more specifically, the second bi-directional pump 3 delivers the hydraulic liquid to the accumulator 7A through the entire second supply/discharge line 32. That is, when the second bi-directional pump 3 is driven in the second direction, the hydraulic liquid delivered from the second bi-directional pump 3 passes through the cooler 8.

In a case where the pressure difference ΔP between the pressure Ph of the head-side chamber 4h and the pressure Pr of the rod-side chamber 4r is less than the threshold Pt, the control circuitry 10 controls the regulator 35 such that the displacement q2 of the second bi-directional pump 3 is the reference displacement qr. That is, in the case of q2=qr, theoretically, there is neither excess nor deficiency in the inflow flow rate to the single-rod cylinder 4 or in the outflow flow rate from the single-rod cylinder 4. Accordingly, the supply of the hydraulic liquid to the head-side line 21 or the rod-side line 22 from the accumulator 7A through part of the second bridge line 54, the relay line 71, and part of the second supply/discharge line 32 is not performed, and the discharge of the hydraulic liquid from the head-side line 21 or the rod-side line 22 through the first discharge line 61 or the second discharge line 62 is not performed.

On the other hand, in a case where the pressure difference ΔP is greater than or equal to the threshold Pt, the control circuitry 10 controls the regulator 35 such that the displacement q2 of the second bi-directional pump 3 is less than the reference displacement qr by a second predetermined amount Δq2, i.e., q2=qr−Δq2. The second predetermined amount Δq2 may be the same as or different from the aforementioned first predetermined amount Δq1. For example, Δq2 is within a range from 1 to 10% of qr.

For example, in a case where a load in the extending direction is applied to the single-rod cylinder 4, the pressure Pr of the rod-side chamber 4r becomes higher than the pressure Ph of the head-side chamber 4h by the threshold Pt or greater, and in a case where a load in the retracting direction is applied to the single-rod cylinder 4, the pressure Ph of the head-side chamber 4h becomes higher than the pressure Pr of the rod-side chamber 4r by the threshold Pt or greater.

In a case where the pressure Pr of the rod-side chamber 4r has become higher than the pressure Pr of the head-side chamber 4h by the threshold Pt or greater, the low-pressure selection valve 6 is switched to the head-side discharge position. As a result, an excess amount corresponding to the second predetermined amount Δq2 is discharged from the head-side line 21 to the accumulator 7A through the first discharge line 61, the low-pressure selection valve 6, the third discharge line 63, and part of the second supply/discharge line 32.

On the other hand, in a case where the pressure Ph of the head-side chamber 4h has become higher than the pressure Pr of the rod-side chamber 4r by the threshold Pt or greater, the low-pressure selection valve 6 is switched to the rod-side discharge position. As a result, an excess amount corresponding to the second predetermined amount Δq2 is discharged from the rod-side line 22 to the accumulator 7A through the second discharge line 62, the low-pressure selection valve 6, the third discharge line 63, and part of the second supply/discharge line 32.

As described above, in the hydraulic system 1A of the present embodiment, since the cooler 8 is located on the second supply/discharge line 32, when the hydraulic liquid is returned from the second bi-directional pump 3 to the accumulator 7A, the hydraulic liquid is cooled.

Therefore, the hydraulic liquid can be cooled in the configuration in which the first bi-directional pump 2 and the second bi-directional pump 3 are used for the single-rod cylinder 4.

In addition, in the present embodiment, the occurrence of pressure confinement on either the rod side or the head side, whichever side has a lower pressure, can be prevented in a simple manner by an action of the low-pressure selection valve 6. The rod side means the rod-side chamber 4r and the rod-side line 22, and the head side means the head-side chamber 4h and the head-side line 21.

### Variations

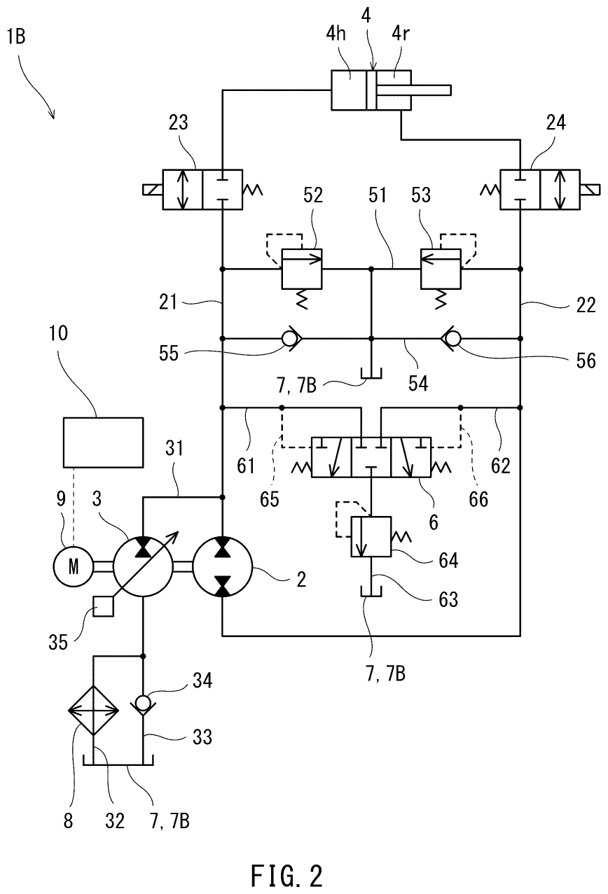

As in a hydraulic system 1B shown in FIG. 2, which is a variation of the hydraulic system, the storage equipment 7 may be a tank 7B. That is, the second bi-directional pump 3 may be connected to the tank 7B by the second supply/discharge line 32. In this case, the parallel line 33 and the third discharge line 63 are connected to the tank 7B, and also, a portion of the first bridge line 51 between the relief valves 52 and 53 and a portion of the second bridge line 54 between the check valves 55 and 56 are connected to the tank 7B. According to this configuration, when the hydraulic liquid is returned from the second bi-directional pump 3 to the tank 7B, the hydraulic liquid is cooled. The present variation, i.e., the storage equipment 7 may be the tank 7B, is applicable also to Embodiment 2 and Embodiment 3, which are described below.

However, if the storage equipment 7 is the accumulator 7A as in the above-described embodiment, when the second bi-directional pump 3 starts rotating in a direction to deliver the hydraulic liquid through the first supply/discharge line 31, cavitation due to a pressure decrease on the suction side of the second bi-directional pump 3 can be prevented. Moreover, at the start of the rotation of the first bi-directional pump 2, when the pressure on the suction side of the first bi-directional pump 2 has decreased due to a delay of the return of the hydraulic liquid to the suction side, the hydraulic liquid that is in a pressurized state is supplied from the accumulator 7A to the suction side via the check valve 55 or 56. This makes it possible to also prevent cavitation on the suction side of the first bi-directional pump 2.

### Embodiment 2

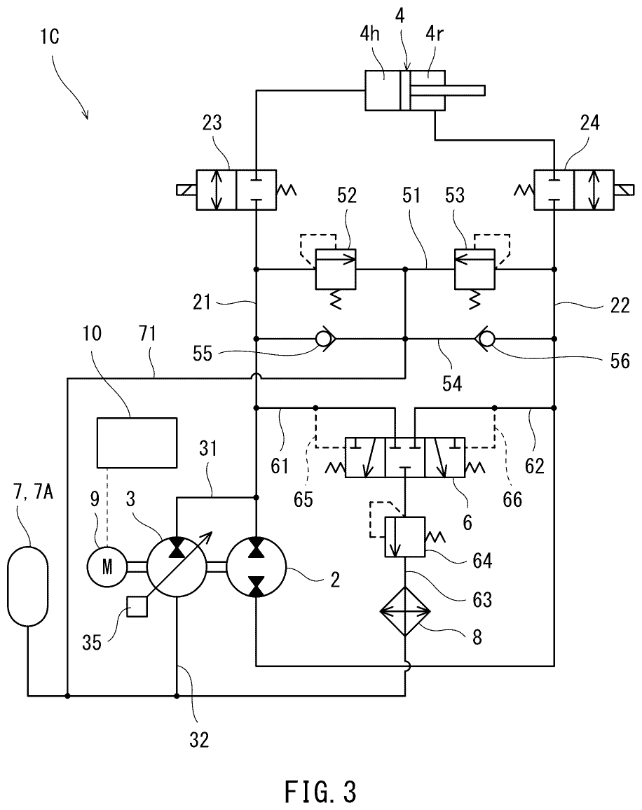

FIG. 3 shows a hydraulic system 1C according to Embodiment 2. In the present embodiment and the following Embodiment 3, the same components as those described in Embodiment 1 are denoted by the same reference signs as those used in Embodiment 1, and repeating the same descriptions is avoided.

The hydraulic system 1C is different from the hydraulic system 1A of Embodiment 1 in that, in the hydraulic system 1C, the cooler 8 is located not on the second supply/discharge line 32, but on a portion of the third discharge line 63 between the relief valve 64 and the second supply/discharge line 32. Accordingly, the parallel line 33 shown in FIG. 1 is not adopted in the hydraulic system 1C.

In the present embodiment, since the cooler 8 is located on the third discharge line 63, when the hydraulic liquid is returned to the accumulator 7A through the third discharge line 63, the hydraulic liquid is cooled. Therefore, the hydraulic liquid can be cooled in the configuration in which the first bi-directional pump 2 and the second bi-directional pump 3 are used for the single-rod cylinder 4. In addition, similar to Embodiment 1, the occurrence of pressure confinement on either the rod side or the head side, whichever side has a lower pressure, can be prevented in a simple manner by an action of the low-pressure selection valve 6.

### Embodiment 3

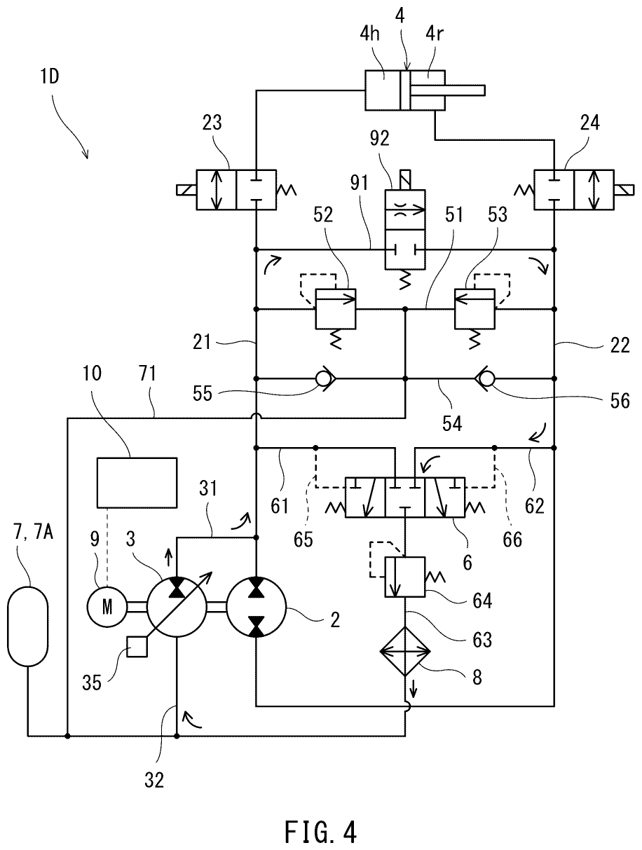

FIG. 4 shows a hydraulic system 1D according to Embodiment 3. The hydraulic system 1D is different from the hydraulic system 1C of Embodiment 3 in that, in the hydraulic system 1D, a bypass line 91 is connected to the head-side line 21 and the rod-side line 22 in a manner to bypass the single-rod cylinder 4. The first lock valve 23 is located on the head-side line 21 between the single-rod cylinder 4 and a position where the bypass line 91 is connected to the head-side line 21, and the second lock valve 24 is located on the rod-side line 22 between the single-rod cylinder 4 and a position where the bypass line 91 is connected to the rod-side line 22.

A bypass valve 92, which is an on-off valve, is located on the bypass line 91. In the present embodiment, when the bypass valve 92 opens, the bypass valve 92 functions as a restrictor. However, when the bypass valve 92 opens, the bypass valve 92 need not function as a restrictor. Instead, a restrictor may be located on the bypass line 91 between the head-side line 21 and the bypass valve 92 or between the bypass valve 92 and the rod-side line 22.

The bypass valve 92 is controlled by the control circuitry 10. When the single-rod cylinder 4 is stopped, as described in Embodiment 1, the first lock valve 23 and the second lock valve 24 are closed. When the single-rod cylinder 4 is stopped, the control circuitry 10 opens the bypass valve 92, and also, rotates the second bi-directional pump 3 in a direction to deliver the hydraulic liquid through the first supply/discharge line 31. Accordingly, as indicated by arrows in FIG. 4, the hydraulic liquid delivered from the second bi-directional pump 3 circulates in a manner to flow through the first supply/discharge line 31, part of the head-side line 21, the bypass line 91, part of the rod-side line 22, the second discharge line 62, the third discharge line 63, and part of the second supply/discharge line 32 in this order. During the circulation, the hydraulic liquid passes through the cooler 8. Thus, the hydraulic liquid can be cooled by utilizing a period when the single-rod cylinder 4 is stopped. Moreover, the hydraulic liquid in the closed loop formed by the single-rod cylinder 4, the head-side line 21, the rod-side line 22, and the first bi-directional pump 2 can also be cooled.

Furthermore, in the present embodiment, the bypass valve 92 functions as a restrictor when the bypass valve 92 opens. Accordingly, the low-pressure selection valve 6, which is a pilot-type three-position valve, can be operated by utilizing a pressure difference that occurs as a result of the hydraulic liquid passing though the bypass valve 92.

Embodiment 1 may adopt the bypass line 91 and the bypass valve 92, and also in Embodiment 1, when the single-rod cylinder 4 is stopped, the bypass valve 92 may be opened and the second bi-directional pump 3 may be rotated in a direction to deliver the hydraulic liquid through the first supply/discharge line 31. The bypass line 91 and the bypass valve 92 are adoptable also in the variation of Embodiment 1 shown in FIG. 2.

### Other Embodiments

The present disclosure is not limited to the above-described embodiments. Various modifications can be made without departing from the scope of the present disclosure.

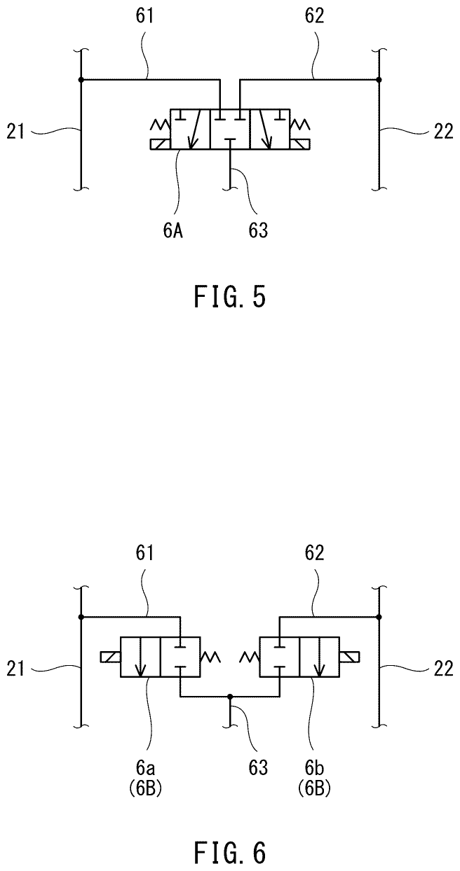

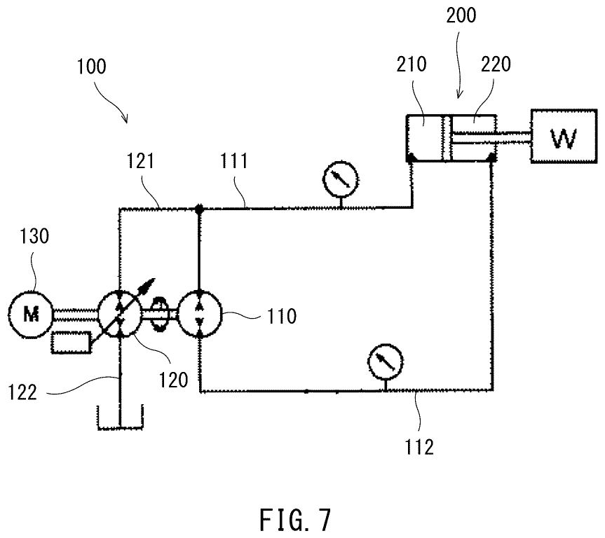

For example, a low-pressure selection valve 6A, which is a solenoid three-position valve as shown in FIG. 5, may be adopted instead of the pilot-type low-pressure selection valve 6. Alternatively, a low-pressure selection valve 6B including a first solenoid valve 6a and a second solenoid valve 6b, each of which is a solenoid two-position valve as shown in FIG. 6, may be adopted instead of the pilot-type low-pressure selection valve 6. The first discharge line 61 and the third discharge line 63 are connected to the first solenoid valve 6a, and the second discharge line 62 and the third discharge line 63 are connected to the second solenoid valve 6b.

### Summary

One aspect of the present disclosure provides, as a first mode, a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line and connected to storage equipment by a second supply/discharge line; an electric motor that drives the first bi-directional pump and the second bi-directional pump in a same direction; and a cooler located on the second supply/discharge line.

According to the above configuration, since the cooler is located on the second supply/discharge line, when the hydraulic liquid is returned from the second bi-directional pump to the storage equipment, the hydraulic liquid is cooled. Therefore, the hydraulic liquid can be cooled in the configuration in which the first bi-directional pump and the second bi-directional pump are used for the single-rod cylinder.

As a second mode, in the first mode, the hydraulic system may further include a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line. According to this configuration, the occurrence of pressure confinement on either the rod side or the head side, whichever side has a lower pressure, can be prevented in a simple manner by an action of the low-pressure selection valve.

Another aspect of the present disclosure provides, as a third mode, a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line and connected to storage equipment by a second supply/discharge line; an electric motor that drives the first bi-directional pump and the second bi-directional pump in a same direction; a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and a cooler located on the third discharge line.

According to the above configuration, since the cooler is located on the third discharge line, when the hydraulic liquid is returned to the storage equipment through the third discharge line, the hydraulic liquid is cooled. Therefore, the hydraulic liquid can be cooled in the configuration in which the first bi-directional pump and the second bi-directional pump are used for the single-rod cylinder. In addition, the occurrence of pressure confinement on either the rod side or the head side, whichever side has a lower pressure, can be prevented in a simple manner by an action of the low-pressure selection valve.

As a fourth mode, in any of the first to third modes, the storage equipment may be an accumulator. According to this configuration, when the second bi-directional pump starts rotating in a direction to deliver the hydraulic liquid through the first supply/discharge line, cavitation due to a pressure decrease on the suction side of the second bi-directional pump can be prevented.

As a fifth mode, in any of the first to fourth modes, the hydraulic system may further include: a bypass valve located on a bypass line, the bypass valve being an on-off valve, the bypass line being connected to the head-side line and the rod-side line in a manner to bypass the single-rod cylinder; a first lock valve that is an on-off valve and that is located on the head-side line between the single-rod cylinder and a position where the bypass line is connected to the head-side line; and a second lock valve that is an on-off valve and that is located on the rod-side line between the single-rod cylinder and a position where the bypass line is connected to the rod-side line. According to this configuration, in a state where the first lock valve and the second lock valve are closed and the bypass valve is opened, when the second bi-directional pump is rotated in a direction to deliver the hydraulic liquid through the first supply/discharge line, the hydraulic liquid delivered from the second bi-directional pump circulates in a manner to flow through the first supply/discharge line, part of the head-side line, the bypass line, part of the rod-side line, the second discharge line, the third discharge line, and part of the second supply/discharge line in this order. During the circulation, the hydraulic liquid passes through the cooler. Thus, the hydraulic liquid can be cooled by utilizing a period when the single-rod cylinder is stopped.

As a sixth mode, in the fifth mode, when the bypass valve opens, the bypass valve may function as a restrictor. According to this configuration, in a case where the low-pressure selection valve is a pilot-type three-position valve, the low-pressure selection valve can be operated by utilizing a pressure difference that occurs as a result of the hydraulic liquid passing through the bypass valve.

As a seventh mode, in any of the second to sixth modes, for example, the low-pressure selection valve may be a solenoid three-position valve.

As an eighth mode, in any of the second to sixth modes, for example, the low-pressure selection valve may include a first solenoid valve and a second solenoid valve, each of which is a solenoid two-position valve; the first discharge line and the third discharge line are connected to the first solenoid valve; and the second discharge line and the third discharge line are connected to the second solenoid valve.

1. A hydraulic system for a single-rod cylinder including a head-side chamber and a rod-side chamber, the hydraulic system comprising:
a first bi-directional pump connected to the head-side chamber by a head-side line and connected to the rod-side chamber by a rod-side line;
a second bi-directional pump connected to the head-side line by a first supply/discharge line and connected to storage equipment by a second supply/discharge line;
an electric motor that drives the first bi-directional pump and the second bi-directional pump in a same direction; and
a cooler located on the second supply/discharge line.

2. The hydraulic system according to claim 1, further comprising a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line.

3. A hydraulic system for a single-rod cylinder including a head-side chamber and a rod-side chamber, the hydraulic system comprising:
a first bi-directional pump connected to the head-side chamber by a head-side line and connected to the rod-side chamber by a rod-side line;
a second bi-directional pump connected to the head-side line by a first supply/discharge line and connected to storage equipment by a second supply/discharge line;
an electric motor that drives the first bi-directional pump and the second bi-directional pump in a same direction;
a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and
a cooler located on the third discharge line.

4. The hydraulic system according to claim 1, wherein the storage equipment is an accumulator.

5. The hydraulic system according to claim 1, further comprising:
a bypass valve located on a bypass line, the bypass valve being an on-off valve, the bypass line being connected to the head-side line and the rod-side line in a manner to bypass the single-rod cylinder;
a first lock valve that is an on-off valve and that is located on the head-side line between the single-rod cylinder and a position where the bypass line is connected to the head-side line; and
a second lock valve that is an on-off valve and that is located on the rod-side line between the single-rod cylinder and a position where the bypass line is connected to the rod-side line.

6. The hydraulic system according to claim 5, wherein when the bypass valve opens, the bypass valve functions as a restrictor.

7. The hydraulic system according to claim 2, wherein the low-pressure selection valve is a solenoid three-position valve.

8. The hydraulic system according to claim 2, wherein:
the low-pressure selection valve includes a first solenoid valve and a second solenoid valve, each of which is a solenoid two-position valve;
the first discharge line and the third discharge line are connected to the first solenoid valve; and
the second discharge line and the third discharge line are connected to the second solenoid valve.

9. The hydraulic system according to claim 2, wherein the storage equipment is an accumulator.

10. The hydraulic system according to claim 3, wherein the storage equipment is an accumulator.

11. The hydraulic system according to claim 2, further comprising:
a bypass valve located on a bypass line, the bypass valve being an on-off valve, the bypass line being connected to the head-side line and the rod-side line in a manner to bypass the single-rod cylinder;
a first lock valve that is an on-off valve and that is located on the head-side line between the single-rod cylinder and a position where the bypass line is connected to the head-side line; and
a second lock valve that is an on-off valve and that is located on the rod-side line between the single-rod cylinder and a position where the bypass line is connected to the rod-side line.

12. The hydraulic system according to claim 3, further comprising:
a bypass valve located on a bypass line, the bypass valve being an on-off valve, the bypass line being connected to the head-side line and the rod-side line in a manner to bypass the single-rod cylinder;
a first lock valve that is an on-off valve and that is located on the head-side line between the single-rod cylinder and a position where the bypass line is connected to the head-side line; and
a second lock valve that is an on-off valve and that is located on the rod-side line between the single-rod cylinder and a position where the bypass line is connected to the rod-side line.

13. The hydraulic system according to claim 11, wherein when the bypass valve opens, the bypass valve functions as a restrictor.

14. The hydraulic system according to claim 12, wherein when the bypass valve opens, the bypass valve functions as a restrictor.

15. The hydraulic system according to claim 3, wherein the low-pressure selection valve is a solenoid three-position valve.

16. The hydraulic system according to claim 3, wherein:
the low-pressure selection valve includes a first solenoid valve and a second solenoid valve, each of which is a solenoid two-position valve;
the first discharge line and the third discharge line are connected to the first solenoid valve; and
the second discharge line and the third discharge line are connected to the second solenoid valve.
